(19) United States
(12) Patent Application Publication
(10) Pub. No.: US 2008/0091516 A1
(43) Pub. Date: Apr. 17, 2008

(54) RESPONSE MONITORING SYSTEM FOR AN ADVERTISING CAMPAIGN

(76) Inventor: Giovanni Giunta, Pretoria (ZA)

Correspondence Address: HAHN AND MOODLEY, LLP, P.O. BOX 52050, MINNEAPOLIS, MN, 55402, US

(21) Appl. No.: 11/873,621

(22) Filed: Oct. 17, 2007

Related U.S. Application Data
(60) Provisional application No. 60/829,717, filed on Oct. 17, 2006.

(51) Int. Cl. G06Q 30/00; G06F 17/30; G06F 17/40

(52) U.S. Cl. 705/10

(57) ABSTRACT

The system 11 includes an advertiser of the system 1101 which has joined an analytics network via client campaign server 301. The advertiser 1101 uses the analytics network to capture responses to each of his advertising placements 405. Responses originating from each advertising placement 405 are stored in the history 705 of the database 306 of each client campaign server 301. These responses will be specific to the individual advertising placements 405 which have been placed on any radio 1102 or television 1013, magazine 1104 or newspaper 1105 publication.

This application claims the benefit of priority to U.S. provisional patent application 60/829,717 filed 17 Oct. 2006.

### FIELD

This invention relates to the field of advertising and particularly to a response monitoring and advertisement placement planning system for an advertising campaign that is run using various advertising mediums.

### BACKGROUND

Advertisers, who typically invest in traditional media advertising campaigns like television, radio, magazines, newspapers, and the like, are constantly looking for ways to measure the effectiveness of, and responses to, their advertising campaigns. Research has indicated that as much as US$ 25 billion of traditional media advertisement is wasted on ineffective media placements because advertisers have no way of identifying which media placements are working best to generate a return on investment from their advertising campaigns.

As a result, traditional media has only seen modest growth in the past few years of around 3% to 5% per year as advertisers move their budgets to advertising options that provide them with greater measurement capabilities.

One such advertising medium is online advertising, which has seen explosive growth of around 25%-35% annually. In contrast with traditional forms of advertising like radio, television, magazine and newspaper publications, online advertising has provided advertisers with detailed measurement capabilities to track the success of each media placement, as well as provide information to best target their campaigns. With these measurement capabilities, advertisers are able to immediately judge the success of individual online placements allowing these advertisers to best target their advertising placements to improve their campaign effectiveness.

While traditional media has advanced in terms of providing response measurement capabilities, these measurement capabilities have often been restricted to providing advertisers with more accurate audience rating, such as how many people would read a particular newspaper or magazine on a given day, or would listen to a specific radio broadcast or would watch a particular television program.

This measurement would also include an indication of the demographic profiles, like age, gender, population group, and the like, of the consumers who would read, listen to, or watch a specific media choice. While this information has improved the ability for advertisers to target specific media options, these capabilities have done very little to allow advertisers to accurately determine which of their media placements have achieved success and which have not, or provide advertisers with an understanding of which media options used to advertised the products generated the most responses or sales. There is a well known adage amongst advertisers that describes this problem which advertisers face in traditional media: “I know that half of my advertising works—I just don't know which half!”

In general, many conventional advertising campaigns rely on some form of feedback mechanism to enable potential consumers to respond to the advertisements of such a campaign. These mechanisms typically include a call centre contact number, an e-mail address for requesting further particulars, a mobile telephone service allowing a user to request further information using a text message from a mobile telephone, a website address of the advertiser, and/or the like.

Advertisers then typically have a system which keeps track of these responses from consumers for marketing purposes. These existing systems do have shortcomings in the sense that they cannot provide the advertiser with sufficient information on the feedback in response to an advertising campaign to enable them to judge the success of different aspects of such an advertising campaign.

It would therefore be useful to provide advertisers using traditional media some means to improve their media measurement capabilities and thus reduce their wastages using ineffective advertising.

In the specification and claims that follow, a “response mechanism” is to be understood as referring to any means whereby a consumer responds to an advertisement made by an advertiser. Such a means includes: a telephone call made to a call centre, a response submitted to a website, a response submitted via e-mail, and a response submitted via a mobile phone text message. Such a response typically provides feedback on an advertised product and/or constitutes a request for further information relating to the product advertised. It is to be appreciated that the response mechanism includes any suitable mechanism whereby a consumer is able to provide feedback to an advertiser in response to an advertisement.

### SUMMARY

According to the invention there is provided a system for monitoring responses to advertising campaigns which system includes:
a transceiver configured to interface the system with one or more response mechanisms for in use receiving responses to an advertisement, which transceiver is configured to analyse such received responses to identify a manner in which a response was made, an advertisement in response to which the response was submitted, an identity of a consumer making such a response, and a date and time at which the response was submitted; and
an analytics network arranged in communication with the transceiver, which analytics network is configured to analyse the received responses from the transceiver according to a set of specified characteristics so that the advertiser is provided with an indication of responses received according to the characteristics specified.

One or more response mechanisms may be associated with a particular advertisement placed by an advertiser.

The response mechanism may include a computerized telephone call centre which includes a caller identity functionality. The response mechanism may include an e-mail server, a mobile telephone text message server, a web server hosting a website of the advertiser, and/or the like.

In addition, the response may include a unique identifier associated with a certain product advertised so that, when the response is made, the response inherently identifies the product, e.g. a call centre response requesting the consumer to identify the product by pressing a particular key, an e-mail subject line identifying the product, a particular number to which an SMS is sent, or the like.

The advertisement may be placed in media such as newspapers, radio, television, magazines or similar publications, e.g. pamphlets, signs such as billboards, internet advertisements, and/or any similar form of advertising for dissemination promotional information into the public domain.

The transceiver may be configured to interface with the relevant response mechanism to perform such transceivers associated functions, such as identifying a manner in which the response was made, the identity of the consumer, the advertisement to which said response was made, and the like.

The transceiver may be configured to identify the manner in which the response was made by identifying a response mechanism as an e-mail message, or a call centre call received, or a text message received, or a hit on a certain webpage, and/or the like.

The transceiver may be configured to identify a product on which the response was made by being preconfigured to associate a product with a manner in which the response was made. It is to be appreciated that the advertiser may advertise a specific product together with a specific response mechanism, e.g. a product is advertised together with a call centre number, or a product is advertised on a unique webpage, or it is advertised together with an e-mail address. It is also to be appreciated that the advertiser may advertise a specific product together with a number of specific response mechanisms in the same advertisement, e.g. a product is advertised with a call centre contact number, and email address, and a website address.

The specified characteristics according to which the analytics network analyses the received responses from the transceiver may include the product advertised, a time and method of dissemination of such an advertisement, such as a daily radio advertisement or a monthly printed advertisement, the name of the publication, the size of the advertisement, the cost of the advertisement, and the response mechanism advertised with the product. The characteristics may include a website address where the advertisement is hosted, a text message or SMS (Short Message Service) number where additional information is available, or the like. The characteristic may include an e-mail address which, when an e-mail is sent to such an address, the response mechanism automatically replies to the consumer's address with promotional information associated with that specific e-mail address.

It is to be appreciated that the specified characteristics may specify or link a specific product and/or advertisement with a predetermined response mechanism so that the analytics network is able correlate a response to such an advertisement and/or product. In this manner the analytics network is able to provide the user with an indication of how successful a certain type of advertisement was according to manner and time of dissemination of such advertisement.

The analytics network may include a response filter associated with the transceiver, which filter associates each response received by transceiver from a response mechanisms advertised in an advertising placement, allocates a time and date the response was received, identifies which response mechanism was used and matches the response mechanism used to a response mechanism assigned to an advertising placement.

The data thus created by the response filter may be stored in a memory arrangement for storing a history of responses linked to advertisements, a history of consumers and their details, a history of the advertising campaigns run by the advertiser, products advertised by the advertiser, and the like.

The analytics network further includes an analytics engine associated with the memory arrangement for analyzing and tracking the responses to each advertising placement and campaign run by the advertiser.

The analytics engine may be associated with a media planning tool which provides the advertiser with the ability to revise the history of responses stored in the memory arrangement to determine which advertising placements and response mechanisms are the most effective in eliciting a response from consumers for a particular product advertised.

With this information, the advertiser is given the ability to make an informed media planning decision when planning future advertising campaigns. The information assists the advertiser in maximizing the number of responses received using a particular advertising placement and budget.

It is to be appreciated that by the analytics system providing the advertiser with an indication of the responses received according to the specified characteristics, the advertiser is enabled to determined the level of success of a marketing campaign, e.g. exposure achieved using certain advertising channels or placements, exposure versus costs of campaign, number of people reached, and the like. The system can thus be used as a media planning tool for planning future advertising campaigns based on an advertisers previous response history.

Apart from associating the responses received with the corresponding advertising campaign or advertisement, the response filter may identify the consumer responding to an advertising placement, which information is stored in the memory arrangement is available to the analytics engine. The analytics engine may access the history of responses in the memory arrangement to determine whether or not the consumer responded to any other advertising placements of the advertiser. If the consumer has responded previously, the analytics engine may inform the advertiser as to which of the advertisers products advertised and which advertising placements the consumer responded to in the past. With this information an advertiser is able to profile consumers interested in their brand and identify the media that these consumers are most likely to respond to.

The analytics network further includes a media scheduler interface for providing a means for a user of the analytics network to specify the characteristics (as described above) of all advertisements used in the advertiser's advertising campaign.

The media scheduler interface may include a webpage which allows the user to specify the predetermined advertising characteristics, a dedicated software application installed on a computer of the user which software is arranged in communication with the system, or any similar channel whereby the user is able to specify said characteristics.

The analytics network may be interfaced with a central memory arrangement of the response monitoring system. All data stored in the memory arrangement of the analytics network of an advertiser is simultaneously stored in the central memory arrangement, which is in turn is associated with its own central analytics engine.

According to a further aspect of the invention, there is provided a system for monitoring responses to advertising campaigns, which system includes:
a plurality of transceivers, each associated with an advertiser, configured to interface the system with one or more response mechanisms for in use receiving responses to advertisements, which transceivers are configured to analyse such received responses to identify a manner in which a response was made, an advertisement in response to which the response was submitted, an identity of a consumer making such a response, and a date and time at which the response was submitted;
an analytics network arranged in communication with each transceiver, which analytics network is configured to analyse the received responses from the transceiver according to a set of specified characteristics so that advertisers are provided with an indication of responses received according to the characteristics specified; and
a central memory arrangement interfaced with the analytics networks as well as with a central analytics network for analyzing received responses.

The transceivers and analytics networks function in the same manner as described above.

A media response trend monitor is interfaced with the central memory arrangement and permits all advertisers to access the information evaluated by the analytics engine interfaced with the central memory arrangement.

In this manner, a plurality of advertisers may access information pertaining to past advertising campaigns, which information may be used to improve their future campaigns. The interfacing may be achieved via a network interface device, a connection over the internet, or any suitable means of establishing a method of communication between the advertisers.

As information of all advertisers using the system is available to other advertisers using the system, an advertiser is in a position to understand what how many responses to expect from various advertising placements according to specified characteristics such as, for example, by advertising format, product industry category and response mechanisms used, and is provided with information enabling the advertiser to understand which times of the day consumers respond to a particular advertising placement by, for example monitoring responses by time range, and how many days after a particular advertising placement has been placed the placement continues to generate responses.

The system may allow advertisers to compare the success of their advertising placement to that of other advertisers in the same media placement.

All advertisers connected to the system share their response history to advertisements with the central memory arrangement. The central analytics engine provides the analytics engines of the individual advertisers with a real-time response comparison tool. The central analytics engine may provide the advertiser with a real-time comparison of the responses received from an advertising placement if any other advertiser of the system was also advertising in the same advertising placement on the same day.

The central analytics network may include a central media planner interfaced with the central analytics engine as well as with the analytics engines of the individual advertisers, thereby having access to the advertising campaign histories of all advertisers of the system.

Should an advertiser be planning a new media campaign, the advertiser may use the central media planner to evaluate media placements that the advertiser is interested in to predict the average responses that could be expected from each publication or broadcast media by comparing the advertiser's historical results campaign responses in the media from previous advertising campaigns. The advertiser may also compare responses from all advertisers of to the system to provide an even greater opportunity to assess the opportunities available in various advertising placements.

With this information the advertiser may determine an advertisement placement strategy to improve responses in a new advertising campaign. Historical information that may be used to determine or predict the success factors of a new campaign may include analyzing the historical information pertaining to the advertisement formats used, i.e. half page or full page, the days of the week that advertising was placed to compare which days worked best with various daily publications, and the like. The time of the day that advertisement was placed in broadcast media, like radio and television, could also be used to determine which times of the day generated the best results.

The central analytics engine may provide the media planner with the ability to view a historical trend of responses received for various advertising placements as determined by various advertisers' historical campaign responses. The media planner may be able to provide the advertiser with historical comparisons of responses received from individual advertising placements by product and industry classification from all advertisers, as determined by various advertisers' historical campaign responses in various publications.

The invention further provides a method of determining the effectiveness of an advertisement, the method including at least the steps of: —
placing an advertisement using an advertising medium, the advertisement displaying a response mechanism via which a consumer is able to respond to the advertisement;
receiving a plurality of responses to the advertisement;
identifying characteristics associated with each response;
storing the identified characteristics associated with each of the responses in a data storage means; and
analysing the identified characteristics of the responses to determine the effectiveness of the advertisement.

The advertising medium may be selected from the group including: newspaper, radio, television, magazine, internet, pamphlet, and billboard.

The response mechanism may be selected from the group including: SMS, e-mail, and a telephone callcentre

The characteristics associated with each response may be one or more of: a product advertised, a time and method of dissemination of the advertisement, a name of a publication in which the advertisement was placed, a format of the advertisement, a cost of the advertisement, a response mechanism displayed with the advertisement, a response mechanism used to submit the response, and a date and time at which the response was submitted.

The response mechanism may be used to identify a consumer submitting the response.

The effectiveness of the advertisement may be determined by analysing which characteristic(s) associated with the response and therefore, the advertisement, elicits the largest number of responses from consumers.

Responses relating to a plurality of advertisements placed by a plurality of advertisers are received, characteristics associated with each response are identified, the identified characteristics associated with each of the responses are stored in a data storage means, and the identified characteristics of the responses are analysed to determine the effectiveness of the advertisement.

Each advertiser may be able to access data relating to the effectiveness of the advertisement.

The data may be categorised according to the characteristic(s) identified for the responses.

The effectiveness of advertisements placed in the same advertising medium may be compared.

The effectiveness of advertisements advertising the same product may be compared.

The effectiveness of advertisements displaying different response mechanisms may be compared.

A further method according to the invention is a method of determining the historical effectiveness of advertisements, the method including at least the steps of: —
receiving a plurality of responses to advertisements placed in various advertising media by various advertisers, each of which advertisements displays a response mechanism via which a consumer is able to respond to the advertisement;
identifying characteristics associated with each response;
storing the identified characteristics associated with each of the responses in a data storage means;
analysing the identified characteristics of the responses to determine the effectiveness of the advertisement; and
using the analysis of the responses to determine which identified characteristic(s) of the responses and therefore, the advertisements, elicits the most responses from consumers.

The method may be used to plan an advertising campaign according to which identified characteristic(s) elicits the most responses from consumers.

The advertising media may be selected from the group including: newspaper, radio, television, magazine, internet, pamphlet, and billboard.

The response mechanism may be selected from the group including: SMS, e-mail, and a telephone callcentre

The characteristics associated with each response may be one or more of: a product advertised, a time and method of dissemination of the advertisement, a name of a publication in which the advertisement was placed, a format of the advertisement, a cost of the advertisement, a response mechanism displayed with the advertisement, a response mechanism used to submit the response, and a date and time at which the response was submitted.

The response mechanism may be used to identify a consumer submitting the response.

The method may be used to identify the responses submitted by an identified consumer, so as to create a response profile for said consumer by categorizing the consumer's responses by the characteristic(s) associated with the responses.

The effectiveness of the advertisements may be determined by analysing which characteristic(s) associated with the responses and therefore, the advertisements, elicits the largest number of responses from consumers.

### BRIEF DESCRIPTION OF THE DRAWINGS

The invention is now described, by way of non-limiting example, with reference to the accompanying drawings wherein:

FIG. 1 shows, in diagrammatic view, a monitoring system for an advertising campaign, in accordance with the invention;

FIG. 1.2 shows, in diagrammatic view, a more specific embodiment of the monitoring system shown in FIG. 1 where the response mechanism is in the form of an e-mail;

FIG. 1.3 shows, in diagrammatic view, a further embodiment of the monitoring system where the response is in the form of an SMS or text message;

FIG. 2 shows, in table form, one example of the advertising characteristics linking certain products with response mechanisms;

FIG. 3 shows, in diagrammatic view, one possible functional embodiment of the analytics network of the invention;

FIG. 4 shows, in diagrammatic view, steps followed in one embodiment of the invention to specify advertising characteristics using the media scheduler interface;

FIG. 5 shows, in table format, one example of assigned published advertising characteristics according to the steps shown in FIG. 4;

FIG. 6 shows, in table format, one example of assigned broadcast advertising characteristics according to the steps shown in FIG. 4;

FIG. 7 shows, in diagrammatic view, one embodiment of a response filter which associates responses received from advertising campaigns with the correct advertisement or placement;

FIG. 8 shows, in graphical format, the method used by the response filter for assigning responses received on a particular day and at a particular time to an advertising placement;

FIG. 9 shows, in graphical format, the method used by the response filter to assign responses received during a specific time of the day to an advertising placement;

FIG. 10 shows, in diagrammatic view, a general embodiment of the invention analyzing responses from a plurality of advertiser's response mechanisms; and

FIG. 11 shows, in diagrammatic view, a second aspect of the invention relating to an analytics system for measuring responses received in response to advertising campaigns.

### DETAILED DESCRIPTION

With reference to the accompanying drawings, a monitoring system for an advertising campaign, in accordance with the invention, is generally indicated by reference numeral 10. One embodiment of the invention will now be described in more detail.

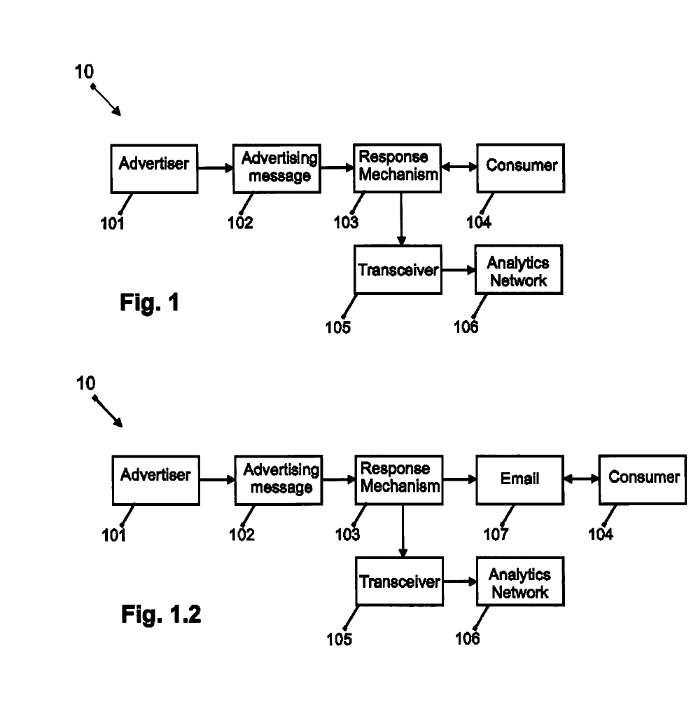

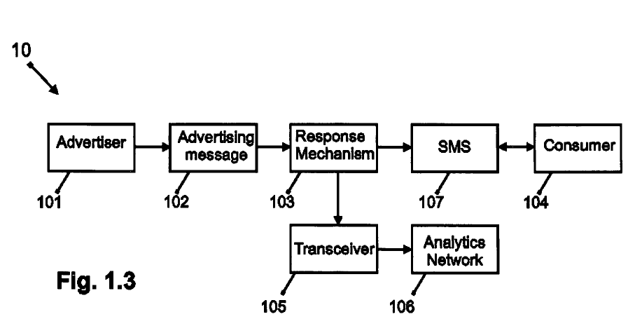

As indicated above, FIG. 1 is a schematic illustrating one possible environment within which the system is generally implemented. In the embodiment shown, the environment includes an advertiser 101, an advertising message 102 disseminated by said advertiser 101 in whichever suitable manner, a response mechanism 103 of the advertiser 101, a consumer 104, a transceiver 105 of the system and an analytics network 106 of the system.

In general, an advertiser 101 refers to any organization that places advertising messages in traditional media advertising campaigns, e.g. radio advertisements, television advertisements, magazine advertisements, internet advertisements, and/or the like. It is to be appreciated that an advertiser 101 may refer directly to an organization which sells a product or service, or to any organization that places the advertising on behalf of the seller, such as an advertising agency, or the like. An advertising message 102 refers to advertising messages placed in any number of traditional media advertising formats like radio, television, newspaper, out-door advertising, magazine advertising, internet advertising, and/or the like.

The response mechanism 103 typically refers to any response method advertised together with the advertising message 102 which consumers would use to respond to the advertising message. Examples of such response mechanism channels may include an advertised call centre number that consumers can call, an e-mail address where consumers could send an e-mail to receive additional product information on the product advertised, and/or an SMS (short message service) or text message service number assigned to the advertising message where consumers could send an SMS to receive additional information. This can include the option to send the SMS together with the consumer's e-mail address to the SMS facility to reply with more information via e-mail, or simply as a blank SMS where the SMS facility can capture the sender's or consumer's cell phone number so that the advertiser 101 is able to call the consumer back with more information. In addition, a further response mechanism channel may include a website address assigned to the advertising message, which the consumer could visit to obtain more information, or the like.

It should be understood that more than one response mechanism may be assigned to a single advertising message, e.g. a newspaper advertisement which includes the response channels of an e-mail address whereby a consumer can respond by sending an e-mail and a call centre number where the consumer can call for additional information.

The consumer 104 refers to the individual who sees, reads, or hears the advertisement and responds to this message using any of the response mechanism channels provided in the advertiser's 101 advertising message 102.

The transceiver 105 refers to the interface configured to communicate with the advertisers' 101 response mechanisms 103 and the analytics network 106. Typically, the transceiver 105 could be identified as a separate software solution that is configured to integrate with the client's or advertisers response mechanism 103.

The analytics network 106 generally refers to some manner of computer system and related functional apparatus configured to receive information from the transceiver 105 pertaining to the responses received by the advertisers' 101 response mechanisms 103. It is to be appreciated that the system will generally interface with a plurality of advertisers' 101 response mechanisms 103. Such information received by the transceiver 105 is then typically stored by the computer system of the analytics network 106.

A method is generally followed to use this received information to provide the advertisers 101 with detailed information regarding the responses to advertising placements including in-depth media measurement capabilities. The transceiver 105 is generally connected to the analytics network 106 via a network connection which is typically the internet or a similar network. The transceiver 105 could also be installed on a separate computer or could even be the same computer or server as the analytics network 106. It is to be appreciated that the functional mechanism of the transceiver 105 and analytics network 106 may be altered and configured according to the requirements and capabilities of the advertisers' response mechanisms 103, or the like.

FIG. 1.2 shows an example of one embodiment of the system to explain the functionality of the transceiver 105 where the response channel is an e-mail response 107 from a consumer 104 responding to an adverting campaign. An advertiser 101 would advertise his advertising message 102 in an advertisement which includes, for example, a radio commercial or a printed advertisement in any newspaper or magazine. In this example the response mechanism 103 assigned to the adverting message 102 would include the use of an e-mail 107 as a method to respond to the advertising campaign. In general, a consumer who sees or hears the advertisement 102 would be given the option to respond to the advertising campaign by sending an e-mail to a designated e-mail address assigned to the advertising message and also then included in such advertisement to this effect.

The e-mail inbox assigned to this e-mail address would be configured to automate a reply to the consumer containing product information, or the e-mail inbox would simply collect messages from consumers inquiring about more product information which the advertiser 101 would monitor and reply to each consumers request individually, or the like. The transceiver 105 would then be configured to monitor the e-mails sent to this dedicated inbox by the consumers 104 responding to the advertisement 102 looking for additional information.

The transceiver 105 is configured to collect the following information from the inbox which could include the time and date the e-mail was received, the e-mail address the e-mail was sent to, to identify which e-mail response mechanism 103 was responded to, as well as the reply e-mail address of the consumer 104 sending the e-mail, to provide a method of identifying the consumer 104 responding to the advertising message 102. The transceiver 105 would then transmit this information to the analytics network 106 to be used to analyze the responses to the advertising message 102.

In a separate example of the invention, as indicated in FIG. 1.3, the response mechanism 103 assigned to the advertiser's 101 advertising message 102 uses a cellular network or mobile telephone short message service or SMS facility 107 to respond to the advertising campaign. The advertiser 101 is able to advertise a specific telephone number that a message could be sent to. The message could simply be sent by the consumer 104 as a blank SMS that would be collected by the advertisers SMS marketing facility, i.e. response mechanism 103. This facility could simply store the consumer's mobile telephone number to allow the advertiser 101 to call the consumer 104 back, or the instructions in the advertising message 102 could include asking the consumer 104 to send the message with his e-mail address in the text of the message to receive an automated e-mail reply containing all the product and sales information pertaining to the product being advertised.

The transceiver 105 is configured to monitor the SMS's received by the advertiser's 101 SMS response mechanism 103 or marketing facility when the consumer 104 responds to the advertising message 102 for more information. The transceiver 105 is configured to collect the following information from the SMS facility or response mechanism 103 which could include the time and date the SMS was received, the cell phone number of the consumer sending the message in reply to the advertising message as a method of identifying the consumer 104, as well as the assigned telephone or SMS number advertised in the advertising message to identify which campaign was being responded to. The transceiver 105 would then transmit this information to the analytics network 106 of the system to be used to analyze the responses to the advertising message 102.

Regardless of the response mechanism 103 used as a means for consumers to respond to the advertising message, transceiver 105 is generally configured to integrate with the technology used to manage these response mechanisms and would be programmed to perform the same functions of collecting the time and date the response was received, collecting information that could be used to identify the consumer responding to advertising message which could include the consumers mobile telephone number or reply e-mail address, IP address, or any similar means available to identify the consumer, and identifying which advertising message was responded to, which could include the e-mail address assigned to advertising message, call centre telephone number or SMS number assigned to the advertising message, and the like. The transceiver 105 is typically programmed to transmit this information to the analytics network 106 to provide the advertiser with statistics of the responses received by his various advertising messages 102.

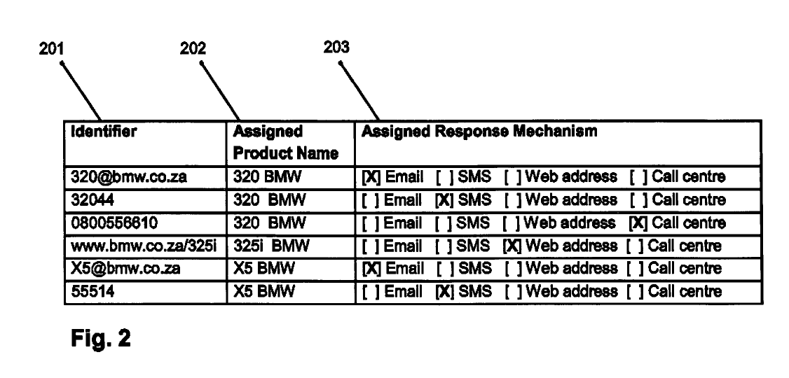

FIG. 2 further shows one example of an embodiment used by the transceiver 105 to identify the response mechanism 103 assigned to the advertiser's advertising messages. FIG. 2 includes an identifier 201, an assigned product 202 and an assigned response mechanism 203. In column 1 the identifier 201 represents the specific response mechanism 103 used in the advertiser's advertising message, e.g. 318@bmw.co.za. In column 2, the assigned product 202 represents the name of the advertiser's product assigned to the identifier 201.

The purpose of assigning a name to the identifier is to provide the analytics network 106 with a means of identifying which response originated from which response mechanism 203 and to provide a simple method for the advertiser 101 to assign each response mechanism 103 with a description that identifies the product associated with such response mechanism. In column 3, the transceiver 105 provides a means to identify the assigned response mechanism 203 or the type of response mechanism used, i.e. e-mail, SMS, web site address, or the like. This information is then registered with the analytics network 106 to provide the advertiser with a clear understanding of which response mechanisms advertised delivered the best responses. This information can then further be used to allow the advertiser to identify which response mechanisms work best with certain advertising messages 102, e.g. radio, television, magazine or newspaper, and the like.

For example, an advertiser like BMW could advertise an advertising message 102 on radio and in a newspaper publication to promote one of their luxury vehicles, for example the 320 BMW. These advertising messages 102 could advertise a simple website URL like “www.bmw.com/320” for consumers to visit for more information, an e-mail address such as “320@bmw.com” as an additional response mechanism as well as an SMS number like “34865”. A consumer who is exposed to this advertisement message could then choose to either send an e-mail or SMS to the advertised e-mail address or SMS number in order to receive more information. He/she can also visit the advertised website address.

The transceiver 105 would be programmed to interface with the e-mail inbox assigned to the advertised e-mail address, i.e. “320@bmw.com”, the SMS facility managing incoming SMS from consumers, and the website URL which could send information to the transceiver every time the web page is opened. The transceiver 105 is configured to assign an identifier 201 to the assigned response mechanism 203 which the transceiver 105 monitors. This identifier 201 could be a computer generated code or the name of the advertised response mechanism, e.g. “320@bmw.co.za”, or could include any suitable means for identifying which responses where received from which response mechanism 103.

The transceiver 105 also generally includes a means to assign a product name 202 or description (e.g. 320 BMW) to this identifier 201 that would be used to identify the advertiser's 101 product assigned to the response mechanism 203. In addition, the transceiver 105 also includes a means of identifying which assigned response mechanism 203 is associated with the identifier 201 to allow the system to distinguish responses originating for the various response mechanisms 103.

The transceiver 105 would then send this information to the analytics network 106 to allow the system and suitable apparatus of the analytics network 106 to identify responses originating from various response mechanisms 103, to match these responses to the product being advertised, and to accurately measure the responses originating from each.

In practice, in one embodiment of the invention, if an advertising campaign generated 10 000 responses, the approach of FIG. 2 would allow the analytics network 106 to receive information from the transceiver 105 by said transceiver 105 tracking the responses that originated from various advertising messages 102. For example if a radio and newspaper advertisement was used with SMS, e-mail, and a website address as assigned response mechanisms 103 and, for instance, the radio advertisement received 2000 SMS responses, 1000 e-mail responses and 1000 web responses and the newspaper advertisement received 2000 SMS responses, 3000 e-mail responses and 1000 web site responses. With the ability to identify and monitor the responses originating from various advertising messages 102 and to distinguish between which assigned response mechanism 203 was used by consumers 104 who responded to the advertising messages 102, the advertiser 101 has the ability to identify, for example, for their radio advertising, that SMS responses generated the highest response rate, and that consumers preferred to use e-mail as a response mechanism when responding to an advertising message in newspaper, or the like.

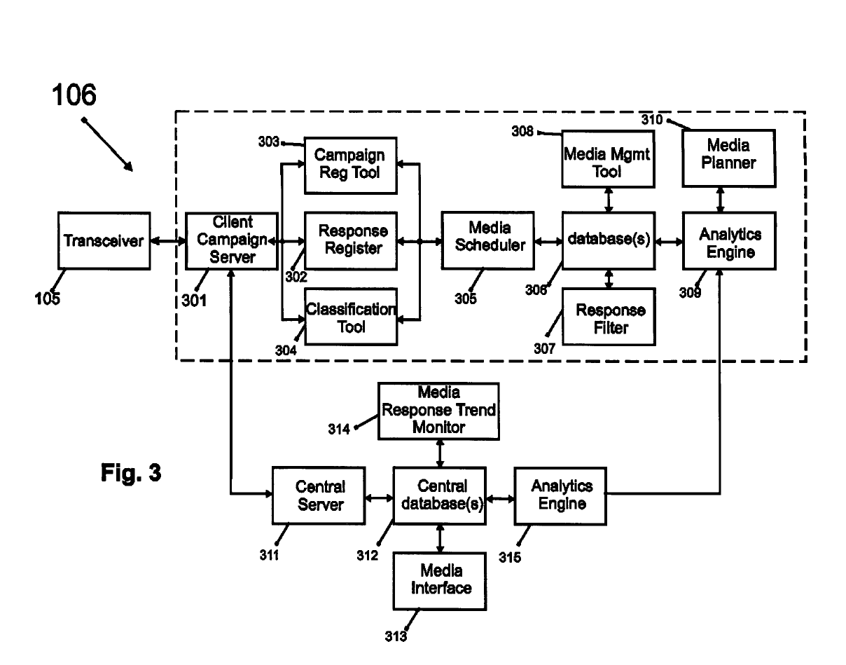

FIG. 3 shows one possible embodiment of the analytics network 106 of the system. The network includes a client campaign server 301 as a method of communicating with the transceiver 105 which is typically a network connection over the internet. In the embodiment shown, the campaign server 301 consists of a response register 302, a campaign registration tool 303, a classification tool 304, a media scheduler 305, a database 306, a media management tool 308, an analytics engine 309 as a means of connecting to a central server 311, such as a network connection via the internet, media planner 310 and a response filter 307 which is used by the client's campaign server 301 to associate responses received by the transceiver 105 from various response mechanisms 103 advertised to the correct advertising placement. In turn, this central server 311 has a central database 312, a media interface 313, a central analytics engine 315 and a media response trend monitor 308. It is to be appreciated that the above components of the analytics network 106 can be arranged in any order, components can also be added or replace those shown.

The client campaign server 301 refers to the network device or server hosting the client's analytics network. The response register 302 of the campaign server 301 is the component of the network which stores a list of assigned response mechanisms 103 which has been assigned to the client's campaign server 301 by the transceiver 105. In order for the campaign server 301 to receive information pertaining to the responses received from various response mechanism 103 sent to the analytics network by the transceiver 105, like time and date of each consumer response, which response mechanism the response originated from, which of the client's advertised products were associated with the response as well as the method to identify the consumer who responded to the advertising message, the client's campaign server 301 of the analytics network 106 would require the transceiver 105 to register these response mechanism's 103 with the response register 302 of the system.

As explained above, the transceiver 105 allows the transceiver 105 to assign an identifier 201 which is associated with the transceiver connection/interface connection with the various response mechanisms 103 which the transceiver 105 has been programmed to create a suitable connection with. The transceiver 105 has a means of assigning this identifier 201 to a suitable descriptor or product name 202.

This descriptor or product name 202 will provide a method of categorizing or linking various response mechanisms 103 so that they may be associated with a specific product of the advertiser 101, or associated with a different product of the advertiser.

The reason for this is so that a single advertising campaign, i.e. a magazine advert, may have more than one response mechanism, i.e. SMS, E-mail and/or website address response mechanisms. In so doing, it allows the client campaign server 301 to identify that responses originating from various response mechanisms are associated with the same advertising campaign or product being advertised. The response register 302 will provide a means of listing or presenting the response mechanisms 103 registered with the system and the advertiser's products that they are associated or linked to.

The client campaign server 301 of the analytics network 106 also includes the campaign registration tool 308. All client campaign servers 301 which forms part of the analytics network 106 will be required to be a registered member of the service, and these registration details will be shared with the central server 311 and stored in the central database 312.

The client campaign server 301 of the system will also include the classification tool 304. The classification tool 304 is a specific feature of the client's campaign server 301 which provides an industry classification of all products and clients registered on the analytics network 106. This includes providing a classification for all of the advertisers' 101 products that have a response mechanism 103 registered in the system's response register 302, as well as providing sub-categories of products according to their classification. Industry classification is typically specific to the industry sector or a defined product category for which the advertisers business and/or products are categorized.

For example, Ford Motor Company could be classified as a motor vehicle manufacturer or motor vehicle retailer, and their vehicle products could be further classified into sub-categories by the system as passenger vehicles, utility vehicles, or the like. In a separate example, the classification tool 304 could provide a classification for products relating to food and beverages and provide a sub-category of products classified under food and beverages as, for example, beverages, confectionery & snacks, dairy, meat, bakery goods, prepared foods, ingredients, mixes & seasonings etc. The method of classifying clients and their products by the classification tool 304 is not restricted to the method as described above and any method could be used by the classification tool 304 to provide a suitable classification of products and clients assigned to the system.

The classification tool 304 also typically lists all products registered in the system's response register 302 and provides the user of the system the ability to assign a reasonable classification to each product or brand assigned to the system.

The classification tool 304 could also provide a predefined list of industry classifications available to the system, or could allow the user to define an own classification which could be added to the system.

In addition, the classification tool 304 could also receive updates from the central server 311 regarding new product classifications that can be used by the system, or those entered into the classification tool 304 of the client's campaign server 301 could update a listing of classifications on the central server 311 which could be made available to all client campaign servers 301 connected to the analytics network 106.

All products classified by the classification tool 304 of the client's campaign server 301 are stored in the system's database 306 and are typically stored as part of the client's registration account in the central database 312. The central database 312 and the client's database 306 exist with an open communication channel constantly updating each other with new information that is entered by the user of the client's campaign server 301. The central database 312 and the database 306 located on the client's campaign server 301 will also store all classifications of products assigned by the classification tool 304 as entered by users in the system.

Also included in the analytics network 106, is the media scheduler 305, the media management tool 308, the database 306 and the analytics engine 309, the media planner 310 and response filter 307 of the client's campaign server 301, and the media interface means 313, the central database 312, and central analytics engine 315 located on the central server 311.

The following describes the typical functionality of the media scheduler 305. The media scheduler 305 is means which provides a way for a user of the analytics network 106 of the client campaign server 301 to enter the details of all advertising messages 102 that will be used in the Advertiser's 101 advertising campaign.

In one embodiment, in practice, when an advertiser 101 of the system decides to place an advertising message 102 on any of the possible advertising mediums, the advertiser 101 would decide on the appropriate budget allocated to such an advertising campaign in order to book media space for these advertising messages 102. It is to be appreciated that these advertising mediums usually have a limited number of advertising spaces available to advertisers on any given time and advertises 101 who want to ensure that they have space available would normally book this space in advance. Advertisers, who follow this practice, will usually obtain a media schedule detailing time and dates when this advertising will appear. For radio and television, the media schedule will detail the selection of stations that will broadcast this advertising (e.g. CNN, MTV, Radio 702), the length of each message in seconds as well as the exact time and date that each will be broadcast.

In a similar fashion, a media schedule for advertising placed in a magazine or a newspaper also provides details of the publication used (e.g. New York Times, Cosmopolitan magazine, or the like) and includes either the exact date the advertising will be displayed if the publication is publishes on a daily basis, or the starting and ending dates of the placement based on the length that the publication is available to their consumers, i.e. monthly magazines or weekly newspapers, including the format or size of advisements placed, e.g. half page, full page or a quarter page advertisement placement.

Additional information that may also be available to the advertiser 101 that pertains to each publisher or broadcast medium used, could include the number of consumers who read the publication, usually referred to as the publications readership or circulation or audience ratings (AR ratings) which refers to the average number of consumers the advertising would be exposed to during a specific time slot on radio or television. The media scheduler 305 would provide a means for the users of the client campaign server 301 to enter all this information as described in detail above into the client campaign server 301, or the like.

The media scheduler 305 includes a new media event tool (not shown) which allows the user to create a new media schedule for an advertising campaign. The even tool allows the user to allocate a campaign name to describe the new event or advertising campaign. For example, the campaign name could be called “August Discount Deal”. The user could provide any name to describe the advertising campaign. The purpose of providing a name is to provide a way to distinguish the advertising campaign from any other campaign currently available on the client campaign server 301, or registered on the system, and to provide a way to create a report specific to the campaign which would be made available via the analytics engine 309.

The media scheduler 305 also includes a means of listing the advertiser's 101 products assigned to the system in the response register 302. As explained in detail above, the response register 302 lists all products that are registered to the client's campaign server 301 by the transceiver 105. All products listed will be assigned to a specific response mechanism 103, i.e. an e-mail address, SMS number, that the advertiser 101 could use in his advertising message 102, e.g. radio, television, newspaper, and/or the like, to provide consumers 104 with a means to respond to his advertising messages.

In use, a user of the media scheduler 305 selects the appropriate products listed in the response register 302 and assigns these to the new campaign. For example, the advertiser's 101 advertising campaign could include advertising for one product or a number of products as required by the advertising campaign. These products could each have one or more response mechanisms 103 as arranged by the advertiser, e.g. a BMW 320 vehicle could have a response mechanism for e-mail responses assigned as “320@bmw.com”, one for SMS responses as “32044” and one to direct visitors to a website domain called “www.bmw.com/320”. For each product that will be advertised in the campaign, the client will allocate all the response mechanisms 103 registered in the response register 302 by the transceiver 105 to the new campaign.

In doing so, the system and the client's campaign server 301 will have a means of tracking the responses from these response mechanisms 103 by identifying which campaign these responses originated from, as well as which campaign these responses should be assigned to. Once the user has identified the name for a new campaign and assigned all the response mechanisms 103 that will be used, the media scheduler 305 provides a way of assigning this media schedule, as described above, to the information received in the advertisers 101 media schedule.

The media scheduler 305 will typically also provide the following approach of assigning the advertising messages 102 to the system. The system will include the media management tool 307 which lists the names of all media properties registered in the system. These media properties may include a list of all radio stations, television stations, magazine titles and newspaper publication which will be registered with the system. The media management tool 308 will receive this list from the central server 311 which will store all media properties registered on the system on the central database 312.

The central server 311 will also provide owners of media properties a method of updating or including their details into the system by using the media interface device 313, typically via an internet access point. If a user of the client server 301 is unable to find the name of a media property registered on the system for use in their media schedule, the media management tool 308 could also provide users of the client campaign server 301 with the ability to add this media property to the system. These properties added by the media management tool 308 will also be added to the central database 312 of the central server 311, and will be available to all client campaign servers 301 connected to the analytics network 106 by the central server 311.

The user of the media scheduler 305 will then use the media properties listed in the media management tool 308 or those added by the user using the media management tool 308 to assign the specific dates and times of each individual media placement together with their corresponding response mechanisms 103 that will be advertised in the advertiser's 101 adverting message 102.

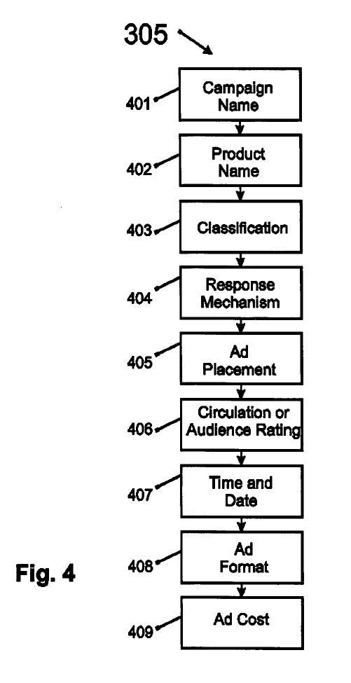

FIG. 4 explains one method of assigning individual media placements by the media scheduler 305. The process details how this information is stored by the database 306 and shared with the central database 312. The process of assigning media placements as described in FIG. 4 will typically be the same for all individual media placements assigned by media scheduler 305.

The process of the media scheduler 305 includes assigning a campaign name 401. The campaign name 401, as described in detail above, provides a method of naming the campaign which is created by the media scheduler's 305 new event tool. For example, BMW could create a new campaign called “Three Series”. The campaign name will be associated with all media placements and products assigned to the campaign. The process then includes assigning a product name 402 to the schedule. Product name 402 will be assigned to the system by the transceiver 105 and will be stored in the response register 302. The response registry 302 will provide the media scheduler with a list of product names available to the system of the client campaign server 301.

The product name 402 is the product that will be advertised in the media placements. For example, the product that is to be advertised could be called the BMW 320. Each product registered in the response registry 302, will also be required to be assigned a classification 403 by the classification tool 304, as explained in detail in the method of classification by the system above. The classification 403 assigned to the product in the response register 302 by the classification tool 304 will also be assigned to the media scheduler 305.

The system of the media scheduler 305 will then provide a method of assigning the appropriate response mechanism 103 associated with the advertisement placement. Each product registered in the response register could have more than one response mechanism assigned to the system by the transceiver 105. For example, the product could have an e-mail address, an SMS number and a web site address. Response mechanism 404 of media scheduler 305 would provide the system with a method of selecting the appropriate response mechanism that will be used in the advertising placement. The media scheduler 305 includes the step of assigning an advertisement placement 405.

The method of assigning the advertisement placement 405 would include accessing a list of media properties available in the media management tool 308 of the invention. As explained, the media management tool will list all radio and television stations, magazine and newspaper publications that are registered with the system. The media scheduler allows the user to select the media property that will be assigned as the advertisement placement 405. This media property will be specific to the individual media advertisement placement 405, e.g. “New York Times” if the placement is a newspaper advertisement or “Radio 702” if the placement is a radio commercial.

Included in the information required by the media scheduler 305 regarding the advertisement placement would be the circulation or audience rating (AR rating) 406 of the advertisement placement 405, the time and date 407 that the advertisement will be available, and the advertisement format 408 relating to the advertisement placement 405. The advertisement format 408 refers to the specific size of the placement in a magazine or newspaper, e.g. half page or full page, or the length of the advertisement in seconds for radio and television. Lastly, the media scheduler will include the ability to assign the advertisement cost or Ad cost 409 which the advertiser 101 will be paying for the advertisement placement 405.

All information captured by the media scheduler 305, as described above, for each individual advertisement placement 405 will be stored in the system's database 306, and will be also be stored in the central database 312 of the central server 311. It is to be appreciated that the databases referred to in the drawings may consist of one database or multiple databases. The process of assigning advertisement placements 405 will be repeated for each advertisement placement 405 assigned to the advertising campaign.

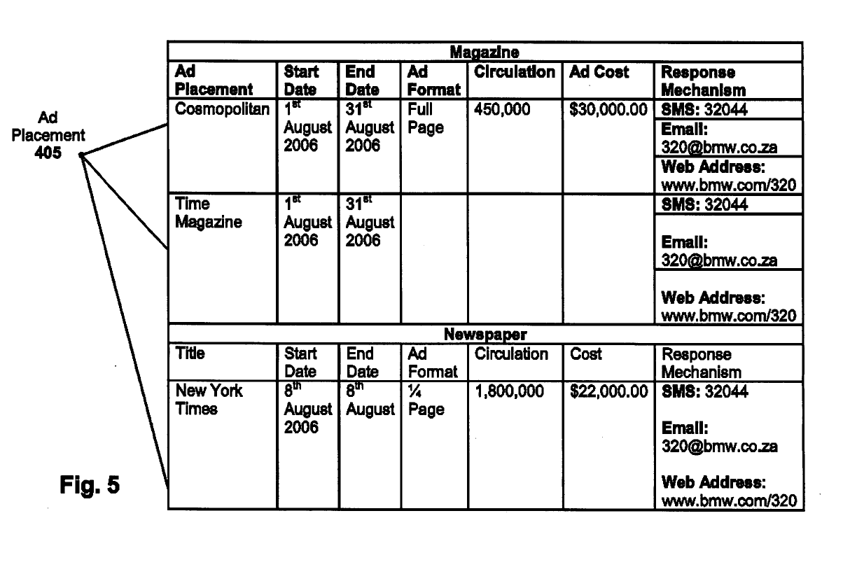

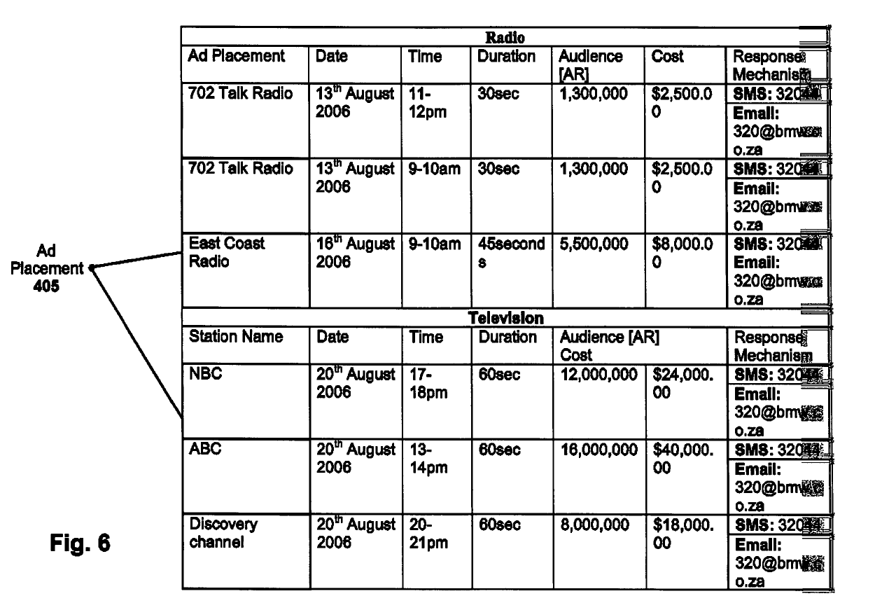

FIG. 5 shows an example of an advertisement placement 405 assigned for a magazine and newspaper publication by the media scheduler 305 as described above. FIG. 6 illustrates an example of an advertisement placement 405 assigned for radio and television by the media scheduler as described above.

As indicated in FIG. 5 and FIG. 6, the method of scheduling media by the media scheduler 305 will include the process as described in FIG. 4 above, for each individual advertisement placement 405 that the advertiser 101 will be using to advertise in a specific media campaign. Information captured for each placement within a campaign will be stored in the database 306 of the clienfs campaign server 301 and will also be stored in the central database 312 of the central server 311.

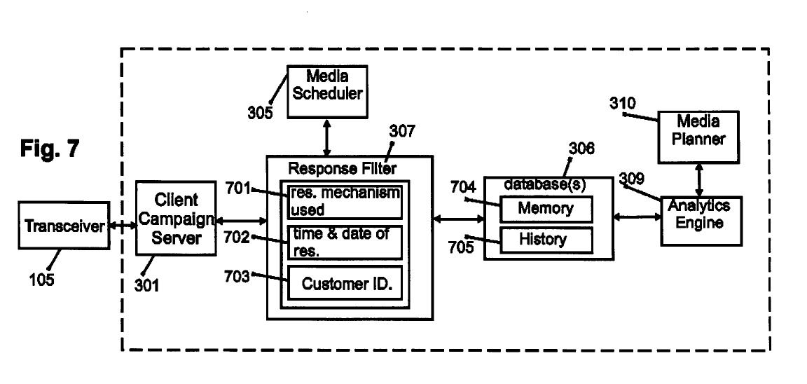

FIG. 7 details the method used by the response filter 307 to associate responses received by the transceiver 105 with specific advertising placements.

FIG. 7 includes a transceiver 105 which receives responses from various response mechanisms assigned to the transceiver 105. A client campaign server 301 receives the responses from the transceiver 105 assigned to the client campaign server 301. A media scheduler 305 is used by the response filter 307 to assign responses received by the transceiver 105 to the correct advertising media placements.

The response filter 307 is configured to assign responses received by the transceiver 105 to an advertising placement assigned to the system by the media scheduler 305. In order to do this, the response filter 307 uses the following steps: it determines which response mechanism was used 701, it determines the time and date 702 on which the response was received, and it determines the identity 703 of the consumer who submitted the response.

Also included is a database 306 which in turn has a memory arrangement 704 for stoning responses received from the transceiver 105. The database 306 also stores information pertaining to each campaign that has been scheduled by the media scheduler 305. The database 306 also includes a history 705 of campaign responses received which have been assigned to advertising placements by the response filter 307.

Once a campaign has been created in the media scheduler 305, the user of the campaign server 301 will assign all the media to the campaign as explained in detail in the method of assigning media to the system using the media scheduler 305. This typically includes a list of all media that the client will be using in his media schedule, detailing a starting date and ending date, or date and time 407 of each advertisement placement. The system of the media scheduler 305 will also provide a method of assigning the response mechanism 404 that will be advertised in each advertisement placement. This information, as explained, will be stored in the database 306 of the invention.

The transceiver 105 will be programmed to establish a communication link through a network interface to the various response mechanisms 103 that will be advertised in the Advertiser's 101 advertising messages 102. When an advertisement placement is published in printed media or broadcast in any broadcast media like television or radio and a consumer 104 makes use of any of the response mechanisms 103 advertised, the transceiver would be programmed to capture these responses from the systems receiving these responses, i.e. the e-mail inbox receiving e-mail responses, a call centre solution receiving incoming calls to a specific call centre number that could be advertised, or a web site URL tracking page open rates.

The transceiver 105 would be programmed to collect the time and date each response was received 702, the response mechanism used 701, as well as a method of recognizing the consumers identity 703 who responded by using the advertised response mechanism 103. Identifying the consumer 104, could include capturing his return e-mail address if an e-mail response was used, his cell phone number if the consumer responded by using a cell phone network SMS facility, or IP address of the consumers visiting an advertised webpage. The transceiver 105 would then send this information via network connection or the internet to the client campaign server 301 and store the information in the memory 704 of the databases 306.

When information pertaining to a consumers 104 response to a response mechanism 103 is sent to the database 306 of the invention by the transceiver 105, the response filter 307 will have a method of associating these responses with a specific campaign and advertising placement created in the media scheduler 305. In so doing, the analytics engine 309 will provide the user of campaign server 301 with a method of analyzing and tracking the response to each advertising placement and campaign as assigned to the system by the media scheduler 305.

The media planning tool 310 provides the user of the client campaign server 301 with the ability to revise the history 705 stored in the database 306 to determine which advertising placements and response mechanisms 404 are the most effective in eliciting a response from consumers for a particular product advertised.

With this information, the advertiser 101 is given the ability to make an informed media planning decision when planning future advertising campaigns. The information assists the advertiser 101 in maximizing the number of responses received using a particular advertising placement and budget.

One method used by the response filter 307 to associate responses sent to the system by the transceiver 105 to the correct advertising placement, would include matching the response mechanism used 701 to response mechanisms 404 assigned to a specific advertising placement by the media scheduler 305. A further method used by the response filter 307 to associate a response to the correct advertising placement, could include matching the time and date 702 a response was received to a time and date 407 assigned to a specific advertisement placement by the method of assigning advertisement placements to the system by the media scheduler 305. If a response mechanism used 701, and the time and date a response was received 702 matches a response mechanism 404 and time and date 407 assigned to an advertising placement by the media scheduler 305, the response filter 307 would automatically associate these responses with the advertising placement and store these responses in the history 705 of responses originating from various advertising placements in the database 306.

For example, referring to FIG. 5, an advertisement placement in Time magazine, as indicated in the table, shows that the advertisement placement as allocated a starting and ending date, e.g. Time Magazine from the 1^{st} to the 31^{st} of August. The advertisement placement is also assigned with three individual response mechanisms 404, i.e. e-mail, SMS and a website URL. In this example, the starting and ending dates of the advertisement placement indicate that the advertisement will be displayed for the entire month. For an advertisement placement, where a starting date and ending date is the same day, e.g. the New York Times on the 8^{th} of August as indicated in FIG. 5, this would indicate that the advertisement placement will only be available on the day advertised. Most newspaper publications would typically publish a new publication every day, while most magazine publishers release a new publication on a monthly basis.

Using the method of associating responses to advertising placements as described in detail above, the response filter 307 would assign all the responses received by these response mechanisms 404 to the advertising placement and the analytics engine 309 would then calculate the number of responses received for the advertisement placement and provide the advertiser 101 with an indication of the responses received according to each advertisement placement. In addition, analytics engine 309 would provide a detailed indication of the exact time that each response was received 702 as indicated by the response filter 307.

Another method of determining whether a response originated from an advertisement placement for broadcast media or printed media would include the ability of the response filter 307 to determine whether any other advertisement placement was available on the date that advertisement placement was broadcast or published. If no other advertisement placement assigned with the same response mechanism 404 is determined to be available on that day by querying a list of advertisement placements stored in the database 306 by the media scheduler 305, then the response filter 307 would determine that these responses originated from the advertisement placement broadcast or published on that day.

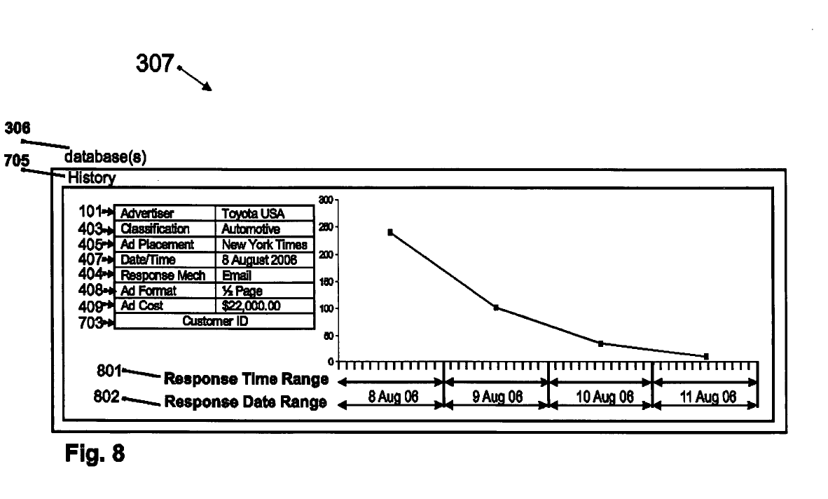

FIG. 8 shows the method used by the response filter 307 for assigning responses received on a particular day and at a particular time to an advertising placement. The responses received for each advertising placement are stored in the history 705 of the database 306. When responses are stored in the history 705 of the database, these responses are assigned according to the advertisers 101 who received the responses, the industry classification 403 provided to the product advertised as assigned to the product by the classification tool 304, the advertising placement which received the responses, the date and time 407 the advertising placement was scheduled as defined by the media scheduler 305, and the response mechanism 404 used in the advertising placement which generated the responses. The method, for example, allows distinguishing between responses originating from various response mechanisms (i.e. email, SMS, call centre or web URL) which were advertised in the same advertising placement.

In instances where the transceiver 105 is able to provide the response filter 307 with a method of identifying the consumer who submitted the response, such consumer identification 703 is associated with the response and stored in the history 705 of the database 305. In case of an email response, referring to the example in FIG. 8, the consumers return email address is stored as a method of identifying the consumer.

In addition to associating each response received with the information which is indicated above, the response filter 307 also stores responses in the history 705 of the database 306 according to the exact time and date on which a response was received 702 as provided to the response filter 307 by the transceiver 105. In doing so, the response filter is able to provide an exact response time range 801 and response date range 802 for responses received from each advertising placement.

It is to be appreciated, that an advertising placement can receive responses after the date 407 that an advertising placement was placed and that the response filter 307 will continue storing responses in the history 705 of responses received for the particular advertising placement until the last response is received. As indicated in FIG. 8, the advertising placement 405 shown as the New York Times, was placed in the publication on the 8^{th} of August 2006. The response filter 307 continued to store responses for the advertising placement 405 until the 11^{th} of August, which indicates that the advertising placement 405 continued to generate responses after the placement date.

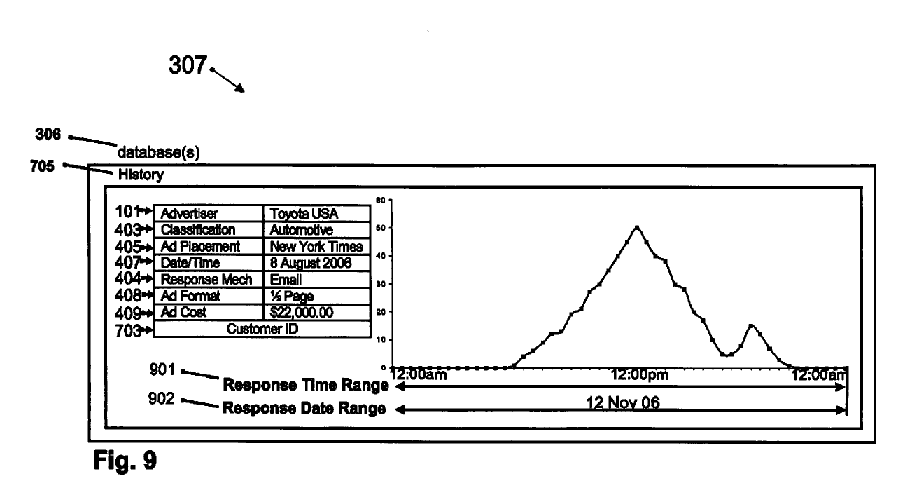

Referring now to FIG. 9, the graphic shows responses received for a particular advertising placement 405 on the 12^{th} of November as indicated by the response date range 902. The response filter 307 stores each response received for a particular day according to the exact time at which the response was received as shown by the response time range 901 for that day. With this information, an advertiser 101 is able to ascertain at which time(s) of the day consumers responded to the advertising placement 405.

It is to be appreciated that the method used by the response filter 307 to store responses in the history 705 of the database 306, will be the same method used to store of responses for each advertising placement 405 scheduled by the media scheduler 305 and for each response mechanism 404 advertised in the advertising placement 405.

It is further to be appreciated that the response filter 307 stores responses received from each advertising placement 405 by the transceiver 105 in the history 705 of the database 306 at the exact time at which the response was received. In doing so, the database 306 stores the responses in the exact time sequence in which they were received, thereby providing the analytics engine 309 and 315 with the ability to identify responses received in response to an advertising placement 405 in any given time interval.

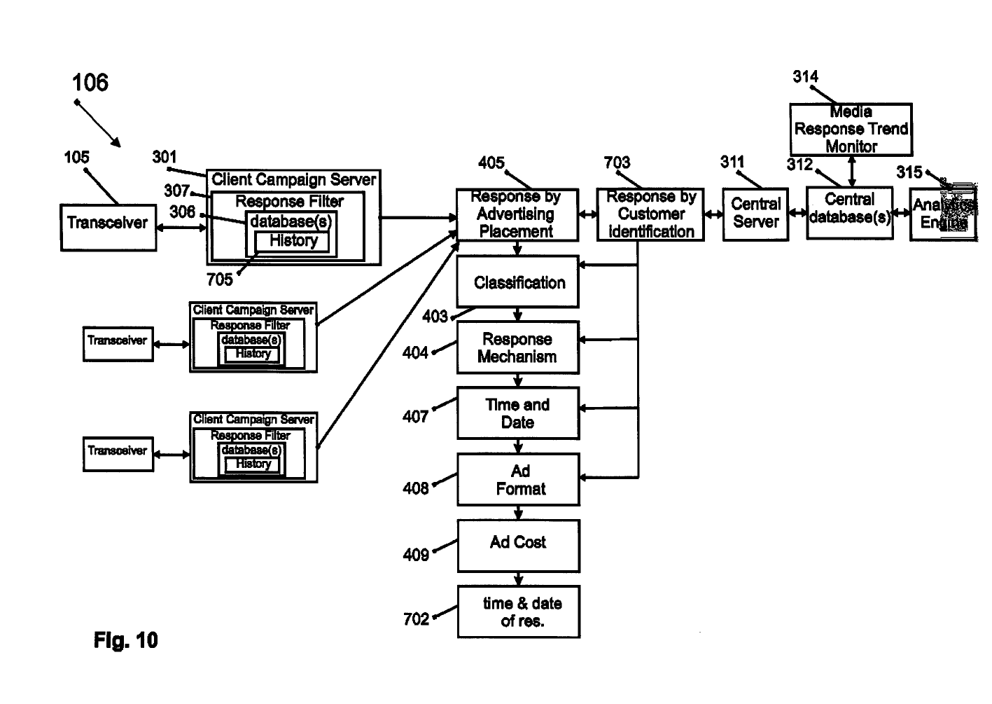

FIG. 10 shows a schematic representation of the analytics network 106 used by the central server 311 to analyze and store responses received in response to advertising placements 405 from all advertisers of analytics network 106.

The analytics network 106 connects all advertisers (not shown) of client campaign servers 301 to the network 106 via the central server 311. The analytics network 106 includes a number of advertisers using the system via individual client campaign servers 301. The central server 311 connects all advertisers to the analytics network 106, and allows the advertisers to share information that can be used to improve their campaign and media measurement ability. It is to be appreciated that the client campaign servers 301 could be different servers hosted in different locations, or could be the same server. It is to be also appreciated that the servers arranged could be connected via a network interface device, a connection over the internet, or any suitable means of establishing a method of communication between each server and device.

As explained with reference to FIGS. 8 and 9, all information stored in the history 705 of responses in the databases 306 pertaining to the responses originating from each advertising placement 405 as assigned to each advertising placement by the response filter 307 will also be stored in the central database 312, accessible to all advertisers of the system 106. This information includes detailed information pertaining to the response time range 801 and 901 and date range 802 and 902.

For each advertisers responses to an individual advertising placement 405, the central server 311 identifies the relevant industry classification 403 of the product 402 advertised by the classification tool 304. The central server 311 also identifies the response mechanism used 404, thereby classifying responses originating from various response mechanisms 404 advertised in the advertising placement 405. The response mechanisms 404 could, for example, be e-mail and SMS.

The central server 311 further identifies the exact date and time 407 at which an advertising placement 405 was scheduled, the ad format 408 used which elicited the responses and the ad cost 409 associated with the advertising placement 405.

In applicable cases, the central server 311 also identifies the consumer 703 responding to the advertising placement 405. The server 311 thus creates a relationship between the consumer (optional) responding to an advertising placement 405, the product classification 403, the response mechanism 404, the time and date 407 on which the advertising placement 405 was placed and the ad format 408 that the consumer responded to.

The information assimilated by the central server 311 for each advertiser's advertising placement 405 is stored in the central database 312. A media response trend monitor 314 is able to use this information to provide analytics engines 309 (not shown) and 315 respectively with detailed response trends calculated from ongoing responses received from the individual client campaign servers 301.

The response trends so identified enhance the advertisers' ability to understand the effectiveness of various media placements according to responses received by industry classification 403, response mechanisms 404, and advertising formats 408 to understand which advertising placement would be best suited to advertise their products.

As information, in particular the response time range 801 and date range 802 in response to an advertising placement 405, of all advertisers using the system is available to other advertisers using the system, an advertiser is in a position to understand how many responses to expect from various advertising placements by ad format 408, product industry category 403 and response mechanisms 404 used, and is provided with information enabling the advertiser to understand which times of the day consumers 104 respond to a particular advertising placement by monitoring responses by time range 801, and how many days after a particular advertising placement 405 has been placed the placement continues to generate responses.

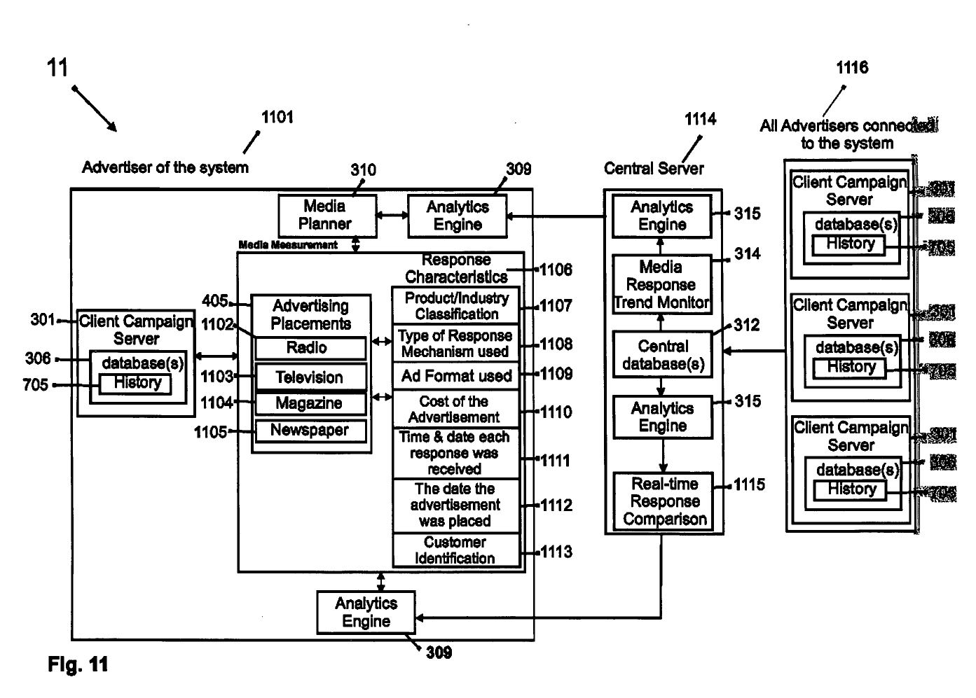

With the understanding of the method used by the system as described in FIG. 10 in which response result of all advertisers using the system are collated and made accessible to all advertisers using the system, a detailed embodiment of the second aspect of the invention which deals with the analytics system and how this aspect of the invention provides media measurement and planning capabilities to each advertiser of client campaign server 301 is described in detail with reference to FIG. 11.

With reference to FIG. 11, an embodiment of an analytics and media measurement system for advertising placements in accordance with the invention is generally indicated by reference numeral 11.

The system 11 includes an advertiser of the system 1101 which has joined the analytics network 106 of FIG. 10 via client campaign server 301. As explained in detail previously, the advertiser 1101 will use the analytics network 106 to capture the responses to each of his advertising placements 405. Responses originating from each advertising placement 405 are stored in the history 705 of the database 306 of each client campaign server 301. These responses will be specific to the individual advertising placements 405 which have been placed on any radio 1102 or television 1013, magazine 1104 or newspaper 1105 publication.

For each advertiser of the system 1101, the response filter will store the following response characteristics 1106 for responses received in response to each advertising placement 405 (e.g. New York Times, Business Day, CNN, Radio 702 etc) received by the transceiver 105: the product classification 1107, type of the response mechanism used 1108, the advertisement format used 1109, the cost of the advertisement 1110, the time and date at which each response was received 1111, the date on which the advertisement was placed 1112, and the consumer identification 1113 associated with the consumer submitted the response. Similarly, all advertisers connected to the system 1116 will also provide the abovementioned information to central server 1114.

The method used by the response filter 307 to associate responses to advertising placements 405 is used by the analytics engine 309 to provide the advertiser of the system 1101 with detailed information pertaining to the responses received from individual advertisement placements 405. This information can be used by the advertiser 1101 to determine which advertisement placement 405 generated the best results to assist the advertiser 1101 in selecting the best media placement 405 for future advertising campaigns. By using information pertaining to the time and date that each response was received 1111, the analytics engine 309 provides the advertiser 1101 with the ability to understand at which times of the day consumers responded to various advertising placements 405 and for what duration the advertising placement generated results after being placed on a certain day. The method used by the response filter 307 to associate a response mechanism used 703 to a specific response sent to the system by the transceiver 105 and stored in the history 705 of responses in the database 306 is used by the analytics engine 309 to determine which type of response mechanism used 1108 generated the highest results. So, for instance, if the advertiser 1101 used SMS and e-mail response mechanisms in a radio campaign, the analytics engine 309 would be able to inform the advertiser 1101 which type of response mechanism worked best for the advertisement placement 405. The system would also be able to inform the advertiser 1101 which response mechanisms 1108 performed the best for various advertisement placements 405 i.e. radio versus a printed publication or from one publication to the next, from the history 705 of responses received from various response mechanisms 404 in the database 306. The advertiser 1101 could then use this information in planning future campaigns to determine which response mechanism 1108 would be most suitable for certain advertisement placements 405.

By using the method of assigning an advertisement format 1109 to a specific advertising placement 405, the analytics engine 309 is able to determine the success of various advertisement formats used 1109 across the client's advertising campaigns by comparing the responses for each. For example, if an advertiser used a half page advertisement in a publication and generated 1000 responses and a week later placed a full page advertisement in the same publication and generated 1200 responses, and the cost of the advertisement 1110 as assigned in the media scheduler 305 indicated that the half page advertisement cost the advertiser $30 000, and the full page $90 000; the advertiser could decide that spending an additional $60 000 for a full page advertisement in the same publication for a small increase in responses in comparison to the half page advertisement was not worth the expenditure. With this information the advertiser 1101 could decide to invest in the half page advertisement in future placements, or even decide to use the money saved to place additional advertising in the publication. This methodology could also be used to determine the most effective advertisement formats on radio or on television.

In instance where the response filter is able to identify the consumer 1113 responding to an advertising placement 405, the analytics engine 309, would be able to use this information to access the history 705 of responses in the database to determine whether or not the consumer responded to any of the other advertising placements 405 of the advertiser. If the consumer has responded previously, the analytics engine 309 informs the advertiser of which of the advertisers products advertised and which advertising placements the consumer responded to in the past. With this information an advertiser is able to profile consumers interested in their brand and identify the media that these consumers are most likely to respond to.

For example, an advertiser like BMW could determine using the analytics engine 309 that a consumer who responded to an advertising placement 405 for one of their brands (e.g. BMW 320i) also responded to another product (e.g. BMW Z4) in the past which was advertised in a different media.

The advertiser also greatly benefits from being able to compare the success of their advertising placement to that of other advertisers in the same media placement 405.

All advertisers connected to the system 1116, share their response history 705 with the central server. The analytics engine 315 provides the analytics engine 309 of the client's campaign server 301 with a real-time response comparison 1115 tool. With this function the analytics engine 309 is able to provide the advertiser with a real-time comparison of the responses received from an advertising placement 405 if any other advertiser of the system was also advertising in the same advertising placement 405 on the same day.

For instance, the real-time response comparison tool 1115 could inform an advertiser whose advertisement appeared in a certain media that products classified under cosmetics by industry classification 1107 achieved “x” average number of responses, or products classified as short term insurance received “y” average number of responses. With this type of information, the advertiser could evaluate whether the responses generated by their advertising was comparable to results generated by another, simultaneous advertisements. If an advertiser, for instance, received only 1000 responses and the average responses from other advertisers in the same media was over 6000, the advertiser could determine that the advertising message was not effective and correct the problem by changing the message for future advertising, or determine that the publication was not suitable to reach the correct target market for their product.

To assist an advertiser in effectively planning their media schedules, the analytics system 11 also includes a media planner 310 function. All advertisers connected to the system 1116 providing the central server 1114 with the history 705 of responses to their advertising placements. The media planner 310 is able to use the analytics engines 309 and 315 to access the history 705 of responses to advertising placements in the advertisers own database by advertising placements 405 as well as that of the central database 312 to offer various media planning capabilities.

If the advertiser is planning a new media campaign, the advertiser uses the functionality of the media planner 310 to look at media placements that the advertisers was interested in using in the new campaign and use the media planner 310 to predict the average responses that could be expected from each publication or broadcast media by comparing the advertisers historical results campaign responses in the media from previous advertising campaigns as assigned to the history 705 of responses to these advertising placements by the response filter 307. The advertiser could also compare responses from all advertisers connected to the system 1116 to provide an even greater opportunity to assess the opportunities available in various advertising placements.

With this information the advertiser could determine an advertisement placement strategy to improve responses in a new advertising campaign. Historical information that could be used to determine or predict the success factors of a new campaign could include analyzing the historical information pertaining to the advertisement formats used, i.e. half page or full page, the days of the week that advertising was placed to compare which days worked best with various daily publications, and the like. The time of the day that advertisement was placed in broadcast media, like radio and television, could also be used to determine which times of the day generated the best results.

The central analytics engine 315 provides the media planner 310 with the ability to view a historical trend of responses received for various advertising placements 405 as determined by various advertisers' historical campaign responses. The media planner 310 is able to provide the advertiser with historical comparisons of responses received from individual advertising placements 405 by product and industry classification 1107 from all advertisers, as determined by various advertisers' historical campaign responses in various publications.

If for example, an advertiser for a hair care product is interested in placing an advertising message in the People Magazine, the media planner 310 is able to provide the advertiser with an indication of the historical response comparison for various advertisers by product classification 1107 who previously advertised in the publication. If the advertiser had information that suggested that a product advertised in the publication similar to their product category received low responses compared to other product categories, the advertiser would be able to make an informed decision when deciding whether or not to advertise in the publication.

In this way the advertiser could save a great deal of money in wasted or ineffective advertising placements. The advertiser could also use the same method of analyzing responses by product category, by using the media planner 310, to display a list of media choices that historically generated successful response averages for products in their product category. The same information could also be useful for media owners who own various publications and broadcast media. Media owners could use the information provided by the history of responses of all advertisers in the central database 312 to target advertisers in specific product categories. For instance, if a media owner could prove the success of advertisers placing advertising in their media for certain product categories, these media owners could target other advertiser selling the same products to advertising with them.

The media planner 310 would also be able to provide advertisers with historical comparisons of responses received by response mechanism used 1108, as determined by various advertisers' historical campaign responses by advertising placement. Advertisers would be able to use this function to determine, based on response volumes received, which response mechanism (i.e. SMS, email, web URL OR Call centre) would generate the best responses in a particular advertising placement.

The media planner 310 would also provide the advertiser the historical response trend by response mechanism and industry classification, detailing the exact time and date each response was received 1111 as provided by each advertiser's historical campaign responses by advertising placement. This includes a response comparison comparing the effectiveness of various advertising formats used 1109 from various advertisers' historical campaign responses by advertising placement.

For example, an advertiser looking to place an advertising campaign in a certain media publication or on a specific television or radio station, could access the central database to find out what the success of various advertisement formats were by industry classification. For example, an advertiser in the used car market might find out that used car advertising in a certain publication generated as many responses for a half page advertisement than it did historically for a full page advertisement from other advertiser's historical campaign responses provided to the system. The advertiser could also determine that a certain advertisement format, for example a 60 second commercial broadcast during a specific time slot, by far outperformed a 30 second commercial in the same time slot. This information could be useful to assist the advertiser in determining which advertisement format would be most suitable to use when advertising in a specific medium.

With regard to the method of the system for storing information that identifies the consumer responding from response mechanism 103 connected to the system by the transceiver 105, the media planner 310 will also be able to provide advertisers the ability to access the central databases 312 and evaluate consumer profiling capabilities.

The media planner 310 has the capability of identifying consumers 104 who responded to the advertiser's advertisement placements 405 using the advertised response mechanism 103, and which also responded to advertising campaigns of other advertisers in certain product categories determined by their historical responses stored in the central database 312. For example, Ford Motor Company could advertise a vehicle categorized by the classification tool 304 under “Sport Utility vehicles”. Consumers who responded to the advertising using e-mail or SMS, would have their e-mail address or cell phone number stored in the central databases 312, as part of the method of the system and response filter 307 for identifying the consumer who responded to the advertising placement. The central analytics engine 315 could identify that certain consumers who responded to the advertiser's advertising, also responded to advertising for household insurance, out door and camping equipment, cosmetic eye wear, and digital cameras.

The system further has the ability to profile consumers according to brand preferences, e.g. consumers who responded to advertising for the Ford Explorer's sport utility vehicle, where also interested in Levi jeans, Diesel sunglasses, Sony camcorders, or the like. This kind of profiling could assist the advertiser in understanding in more detail the profiles of consumers interested in their brands according to their product interests. In addition, the central analytics engine 315 could use the same method of profiling consumer according to their response history by providing information regarding the media that these consumers have used in the past. For example, a consumer who responded to an advertisement placement in People Magazine for brand “x” product, category “y”, was also found to have responded to advertisement placement is several other media choices.

With this kind of information, advertisers would not only be able to build a profile of consumers around the products they are interested in, but the system and method used by the analytics system 11 would also be useful to inform advertisers of the media that these consumers are exposed to, i.e. what radio stations they are listening to, what publication they are reading and which television stations or television programs they are most interested in, simply by monitoring their responses to the advertising placements of all the advertisers connected to the system 1116.

Although only certain embodiments of the invention have been described herein, it will be understood by any person skilled in the art that other modifications, variations, and possibilities of the invention are possible. Such modifications, variations and possibilities are therefore to be considered as falling within the spirit and scope of the invention and hence forming part of the invention as herein described and/or exemplified.

It shall further be understood that the examples are provided for illustrating the invention further and to assist a person skilled in the art with understanding the invention and is not meant to be construed as unduly limiting the reasonable scope of the invention.

1. A system for monitoring responses to advertising campaigns, which system includes:
a transceiver associated with an advertiser configured to interface the system with one or more response mechanisms for in use receiving responses to an advertisement, which transceiver is configured to analyse such received responses to identify a manner in which a response was made, an advertisement in response to which the response was submitted, an identity of a consumer making such a response, and a date and time at which the response was submitted; and
an analytics network arranged in communication with the transceiver, which analytics network is configured to analyse the received responses from the transceiver according to a set of specified characteristics so that the advertiser is provided with an indication of responses received according to the characteristics specified.

2. A system as claimed in claim 1, wherein one or more response mechanisms are associated with a particular advertisement placed by an advertiser.

3. A system as claimed in claim 1, wherein the transceiver identifies the responder via the response mechanism used.

4. A system as claimed in claim 1, wherein the response mechanism includes a unique identifier associated with a certain product advertised.

5. A system as claimed in claim 1, wherein the transceiver is configured to interface with the relevant response mechanism to perform such transceivers associated functions, such as identifying a manner in which the response was made, the identity of the consumer, and the advertisement to which said response was made.

6. A system as claimed in claim 1, wherein the specified characteristics according to which the analytics network analyses the received responses from the transceiver include one or more of the following: the product advertised, a time and method of dissemination of such an advertisement, the name of the publication in which the advertisement was placed, the size of the advertisement, the cost of the advertisement, and the response mechanism advertised with the product.

7. A system as claimed in claim 6, wherein the specified characteristic(s) link(s) a specific product and/or advertisement with a predetermined response mechanism so that the analytics network is able correlate a response to such an advertisement and/or product.

8. A system as claimed in claim 1, wherein the analytics network includes a response filter associated with the transceiver, which filter associates each response received by transceiver from a response mechanisms advertised in an advertising placement, allocates a time and date the response was received, identifies which response mechanism was used, identifies a consumer responding to an advertising placement, and matches the response mechanism used to a response mechanism assigned to an advertising placement.

9. A system as claimed in claim 8, wherein data thus created by the response filter is stored in a memory arrangement for storing a history of responses linked to advertisements, a history of consumers and their details, a history of the advertising campaigns run by the advertiser, products advertised by the advertiser, and the like.

10. A system as claimed in claim 9, wherein the analytics network includes an analytics engine associated with the memory arrangement for analyzing and tracking the responses to each advertising placement and campaign run by the advertiser.

11. A system as claimed in claim 10, wherein the analytics engine is associated with a media planning tool which provides the advertiser with the ability to revise the history of responses stored in the memory arrangement to determine which advertising placements and response mechanisms are the most effective in eliciting a response from consumers for a particular product advertised.

12. A system as claimed in claim 11, wherein the analytics engine accesses the history of responses in the memory arrangement to determine whether or not a consumer identified by the response filter responded to any other advertising placements of the advertiser.

13. A system as claimed in claim 1, wherein the analytics network includes a media scheduler interface for providing a means for a user of the analytics network to specify the characteristics of all advertisements used in the advertisers advertising campaign.

14. A system as claimed in claim 13, wherein the media scheduler interface includes a webpage which allows the user to specify the predetermined advertising characteristics.

15. A system as claimed in claim 13, wherein the media scheduler interface includes a dedicated software application installed on a computer of the advertiser which software is arranged in communication with the system.

16. A system as claimed in claim 1, wherein the system includes a central memory arrangement for storing data.

17. A system as claimed in claim 16, wherein the system includes a central analytics engine for analyzing data.

18. A system as claimed in claim 16, wherein the analytics network is interfaced with the central memory arrangement.

19. A system as claimed in claim 18, wherein data stored in the memory arrangement of the analytics network of an advertiser is shared with the central memory arrangement.

20. A system for monitoring responses to advertising campaigns, which system includes:
a plurality of transceivers, each associated with an advertiser, configured to interface the system with one or more response mechanisms for in use receiving responses to advertisements, which transceivers are configured to analyse such received responses to identify a manner in which a response was made, an advertisement in response to which the response was submitted, an identity of a consumer making such a response, and a date and time at which the response was submitted;
an analytics network arranged in communication with each transceiver, which analytics network is configured to analyse the received responses from the transceiver according to a set of specified characteristics so that advertisers are provided with an indication of responses received according to the characteristics specified; and
a central memory arrangement interfaced with the analytics networks as well as with a central analytics network for analyzing received responses.

21. A system as claimed in claim 20, wherein one or more response mechanisms are associated with a particular advertisement placed by an advertiser.

22. A system as claimed in claim 20, wherein the transceivers identify the responder via the response mechanism used.

23. A system as claimed in claim 20, wherein the response mechanism includes a unique identifier associated with a certain product advertised.

24. A system as claimed in claim 20, wherein the transceivers are configured to interface with the relevant response mechanism to perform such transceivers' associated functions, such as identifying a manner in which the response was made, the identity of the consumer, and the advertisement to which said response was made.

25. A system as claimed in claim 20, wherein the specified characteristics according to which the analytics networks analyses the received responses from the transceivers include one or more of the following: the product advertised, a time and method of dissemination of such an advertisement, the name of the publication in which the advertisement was placed, the size of the advertisement, the cost of the advertisement, and the response mechanism advertised with the product.

26. A system as claimed in claim 25, wherein the specified characteristic(s) link(s) a specific product and/or advertisement with a predetermined response mechanism so that the analytics networks are able correlate a response to such an advertisement and/or product.

27. A system as claimed in claim 20, wherein each analytics network includes a response filter associated with the relevant transceiver, which filter associates each response received by transceiver from a response mechanisms advertised in an advertising placement, allocates a time and date the response was received, identifies which response mechanism was used, identifies a consumer responding to an advertising placement, and matches the response mechanism used to a response mechanism assigned to an advertising placement.

28. A system as claimed in claim 27, wherein data thus created by the response filter is stored in a memory arrangement for storing a history of responses linked to advertisements, a history of consumers and their details, a history of the advertising campaigns run by the advertiser, products advertised by the advertiser, and the like.

29. A system as claimed in claim 28, wherein data stored in the memory arrangement of the analytics networks is shared with the central memory arrangement so that the response histories to advertisements for all advertisers of the system is available in the central memory arrangement

30. A system as claimed in claim 28, wherein each analytics network includes an analytics engine associated with the memory arrangement for analyzing and tracking the responses to each advertising placement and campaign run by the advertiser.

31. A system as claimed in claim 30, wherein the analytics engine accesses the history of responses in the associated memory arrangement to determine whether or not a consumer identified by the response filter responded to any other advertising placements of the advertiser.

32. A system as claimed in claim 20, wherein a media response trend monitor is interfaced with the central memory arrangement and permits all advertisers of the system to access the information evaluated by the central analytics engine.

33. A system as claimed in claim 32, wherein the system allows advertisers to compare the success of their advertising placement to that of other advertisers in the same media placement.

34. A system as claimed in claim 20, wherein the central analytics engine provides the advertisers with a real-time comparison of the responses received from an advertising placement if any other advertiser of the system was also advertising in the same advertising placement on the same day.

35. A system as claimed in claim 20, wherein the central analytics network includes a central media planner interfaced with the central analytics engine as well as with the analytics engines of the individual advertisers, thereby having access to the advertising campaign histories of all advertisers of the system.

36. A system as claimed in claim 35, wherein the central analytics engine provides the media planner with the ability to provide the advertisers of the system with historical comparisons of responses received from individual advertising placements according to specified characteristics.

37. A method of determining the effectiveness of an advertisement, the method including at least the steps of: —
placing an advertisement using an advertising medium, the advertisement displaying a response mechanism via which a consumer is able to respond to the advertisement;
receiving a plurality of responses to the advertisement;
identifying characteristics associated with each response;
storing the identified characteristics associated with each of the responses in a data storage means; and
analysing the identified characteristics of the responses to determine the effectiveness of the advertisement.

38. A method as claimed in claim 37, wherein the advertising medium is selected from the group including: newspaper, radio, television, magazine, internet, pamphlet, and billboard.

39. A method as claimed in claim 37, wherein the response mechanism is selected from the group including: SMS, e-mail, and a telephone callcentre

40. A method as claimed in claim 37, wherein the characteristics associated with each response are one or more of: a product advertised, a time and method of dissemination of the advertisement, a name of a publication in which the advertisement was placed, a format of the advertisement, a cost of the advertisement, a response mechanism displayed with the advertisement, a response mechanism used to submit the response, and a date and time at which the response was submitted.

41. A method as claimed in claim 37, wherein the response mechanism is used to identify a consumer submitting the response.

42. A method as claimed in claim 37, wherein the effectiveness of the advertisement is determined by analysing which characteristic(s) associated with the response and therefore, the advertisement, elicits the largest number of responses from consumers.

43. A method as claimed in claim 37, wherein responses relating to a plurality of advertisements placed by a plurality of advertisers are received, characteristics associated with each response are identified, the identified characteristics associated with each of the responses are stored in a data storage means, and the identified characteristics of the responses are analysed to determine the effectiveness of the advertisement.

44. A method as claimed in claim 43, wherein each advertiser is able to access data relating to the effectiveness of the advertisement.

45. A method as claimed in claim 44, wherein the data is categorised according to the characteristic(s) identified for the responses.

46. A method as claimed in claim 45, wherein the effectiveness of advertisements placed in the same advertising medium is compared.

47. A method as claimed in claim 45, wherein the effectiveness of advertisements advertising the same product is compared.

48. A method as claimed in claim 45, wherein the effectiveness of advertisements displaying different response mechanisms is compared.

49. A method of determining the historical effectiveness of advertisements, the method including at least the steps of: —
receiving a plurality of responses to advertisements placed in various advertising media by various advertisers, each of which advertisements displays a response mechanism via which a consumer is able to respond to the advertisement;
identifying characteristics associated with each response;
storing the identified characteristics associated with each of the responses in a data storage means;
analysing the identified characteristics of the responses to determine the effectiveness of the advertisement; and
using the analysis of the responses to determine which identified characteristic(s) of the responses and therefore, the advertisements, elicits the most responses from consumers.

50. A method as claimed in claim 49, wherein the method is used to plan an advertising campaign according to which identified characteristic(s) elicits the most responses from consumers.

51. A method as claimed in claim 49, wherein the advertising media are selected from the group including: newspaper, radio, television, magazine, internet, pamphlet, and billboard.

52. A method as claimed in claim 49, wherein the response mechanism is selected from the group including: SMS, e-mail, and a telephone callcentre

53. A method as claimed in claim 49, wherein the characteristics associated with each response are one or more of: a product advertised, a time and method of dissemination of the advertisement, a name of a publication in which the advertisement was placed, a format of the advertisement, a cost of the advertisement, a response mechanism displayed with the advertisement, a response mechanism used to submit the response, and a date and time at which the response was submitted.

54. A method as claimed in claim 49, wherein the response mechanism is used to identify a consumer submitting the response.

55. A method as claimed in claim 54, wherein the method is used to identify the responses submitted by an identified consumer, so as to create a response profile for said consumer by categorizing the consumers responses by the characteristic(s) associated with the responses.

56. A method as claimed in claim 49, wherein the effectiveness of the advertisements is determined by analysing which characteristic(s) associated with the responses and therefore, the advertisements, elicits the largest number of responses from consumers.
